(19) United States
(12) Patent Application Publication
(10) Pub. No.: US 2011/0168103 A1
(43) Pub. Date: Jul. 14, 2011

(54) AQUARIUM DRAIN SNAIL GUARD METHOD AND APPARATUS

(76) Inventor: Scott Behar, Scottsdale, AZ (US)

(21) Appl. No.: 12/985,852

(22) Filed: Jan. 6, 2011

Related U.S. Application Data
(60) Provisional application No. 61/294,137, filed on Jan. 12, 2010.

(51) Int. Cl. A01K 63/00

(52) U.S. Cl. 119/259

(57) ABSTRACT

The invention comprises an aquarium drain line attachment or guard apparatus and method for the application thereof. During use, the attachment affixes to the top of an aquarium drain stand pipe. The guard contains a water flow path passing through an opening having physical dimensions limiting passage of snails and/or invertebrates. The silencer includes one or more of: a snail or invertebrate barrier, an angled overflow, a housing, a cap, a drain line size adaptor, and an auto-leveler and/or placement fitting or ring.

### CROSS-REFERENCES TO RELATED APPLICATIONS

This application:
claims benefit of U.S. provisional patent application no. 61/294,137 filed Jan. 12, 2010, all of which is incorporated herein in its entirety by this reference thereto.

### BACKGROUND OF THE INVENTION

1. Field of the Invention

This invention relates generally to an aquarium drain snail guard.

2. Discussion of the Related Art

Patents related to aquarium drains and filters are summarized herein.

A. Jackson, “Aquarium”, U.S. Pat. No. 4,098,230 (Jul. 4, 1978) describes an aquarium having a lower water receiving compartment having communication with a drain, the drain having a flow passage therethrough. Ducts for selectively moving water from the lower compartment operate to remove debris.

A. Shatilov, “Aquarium Surface Sweep Prefilter”, U.S. Pat. No. 5,413,707 (May 9, 1985) describes an aquarium prefilter or surface skimmer using an open collection chamber having a plurality of vents providing communication between the surface water in the aquarium and the interior of the collection chamber. The collection chamber is vertically adjustable to position the vents approximately one-quarter inch below the surface to create a drain functioning to suck in surface dirt.

M. Reinke, “Apparatus for Drawing Water From the Top and Bottom of an Aquarium for Delivery to a Filter”, U.S. Pat. No. 5,901,663 (May 11, 1999) describes a system for drawing water from the top of an aquarium having a horizontal rectangular opening at the surface water line of the aquarium allowing surface water to flow directly into an external tank.

D. Smith, “Water Filtration System”, U.S. Pat. No. 7,604,734 B2 (Oct. 20, 2009) describes a filtration system for an aquarium having a gate chamber with a gate conduit positioned therein that transports unprocessed water from the aquarium.

T. Wong, “Box Filter Structure”, U.S. Pat. No. 7,708,883 B2 (May 4, 2010) describes a box filter having a casing and at least two filters installed inside the casing and behind an influx channel where the filters are separated by a buffer gap.

Problem

There exists in the art a need for preventing snails or invertebrates from clogging an aquarium drain system.

### SUMMARY OF THE INVENTION

The invention comprises a mechanical size filter or guard configured to attach to an aquarium drain stand pipe during use.

### DESCRIPTION OF THE FIGURES

FIG. 1 illustrates a top view (FIG. 1A) and side view (FIG. 1B) of an aquarium guard/stand pipe attachment;

FIG. 2 illustrates an exploded view of a snail guard aquarium stand pipe attachment; and

FIG. 3 illustrates an exploded view of an aquarium attachment.

### DETAILED DESCRIPTION OF THE INVENTION

The invention comprises an aquarium drain line attachment apparatus, grid, or guard and method for the application thereof. More particularly, an attachment affixed to the top of an aquarium drain line prevents snail passage into the drain line with a physical barrier. Still more particularly, a silencer for an aquarium is attached and/or replaceably attached to an aquarium drain line. The silencer or grid silencer includes one or more of: a snail or invertebrate barrier, an angled overflow, a housing, a cap, a drain line size adaptor, and an auto-leveler and/or placement fitting or ring.

Aquariums typically circulate water and blockage or partial blockage of water circulation in an aquarium results in a number of detrimental affects, including water overflow, degraded filtration, and/or improper chemistry balance. For an aquarium configured with a sump, water sequentially flows from the aquarium tank, through a drain system, to the sump, and back to the aquarium via a return system. As chemical, biological, and/or physical filters optionally reside in the sump, any blockage or partial blockage of the water flow to the sump results in unwanted and/or detrimental chemical, biological, and/or physical alteration of the tank water. One particular problem is blockage of the drain system leading from the aquarium tank to the sump by a biological creature, such as an invertebrate or snail. Herein, a system is described for preventing blockage of the drain system. For ease and/or clarity of description, the system is referred to as a guard, grid, snail grid, and/or snail guard and snails are referred to herein as blocking the return line and the apparatus. The term snail guard is exemplary and non-limiting. The guard or snail guard additionally optionally refers to a guard preventing blockage of the drain line by any biological creature.

An axis system is defined relative to gravity. A z-axis is aligned with gravity. An x-, y-plane is perpendicular to the z-axis.

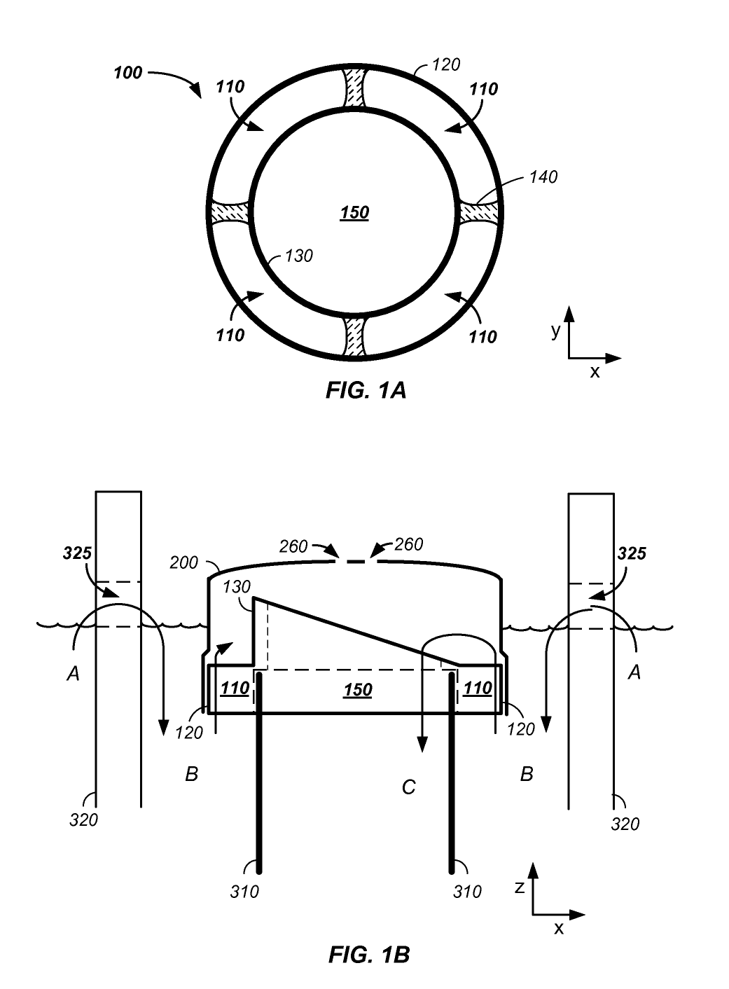

Referring now to FIG. 1A, a top view of a guard attachment or grid attachment 100 to a stand pipe or drain pipe is illustrated. Aquarium water flows up through an opening, aperture, hole, or region 110 between an outer containment wall 120 and an inner containment wall 130, which are optionally separated by one or more spacers 140 or barriers. There are optionally 1, 2, 3, 4, or more openings 110 in the guard attachment 100. Preferably, a distance between the outer wall 120 and inner wall 130 of about ¼, ½, ¾, or 1 inch provides a physical barrier to snails or invertebrates. The physical barrier is referred to herein as a snail guard.

Referring now to FIG. 1B, the guard attachment 100 is illustrated in the context of an aquarium drain system. In one example, water in an aquarium tank, region A, having a tank housing 320 flows through or over an overflow 325 into a drain system containing a stand pipe 310 or drain element. Water in the drain system, region B, rises around the stand pipe 310 and passes through the opening 110 between the outer containment wall 120 and inner containment wall 130 of the guard 100. Subsequently, the water overflows at least a portion of the inner containment wall and falls down through the stand pipe 310, region C, to the sump.

Cover

Still referring to FIG. 1B, the guard 100 optionally contains a cover 200, such as a bell shaped cover. The cover is preferably either integrated into the outer wall 120 of the guard or is replaceably attached to the outer wall of the guard 100. For example, the cover 200 screws onto the guard 100, is slidably engaged with the guard 100, or is formed in manufacturing as a single element piece integrated with the guard 100. Generally, the optional cover 200 provides at least one of:
an outer barrier containing water having risen through the opening 110 of the guard 100; and
a silencer reducing noise resultant from falling or cascading of the water over the inner containment wall 130 of the guard 100 into the stand pipe 310.

The silencer or muffler is also optionally referred to as a “Maggie” muffler.

### EXAMPLE I

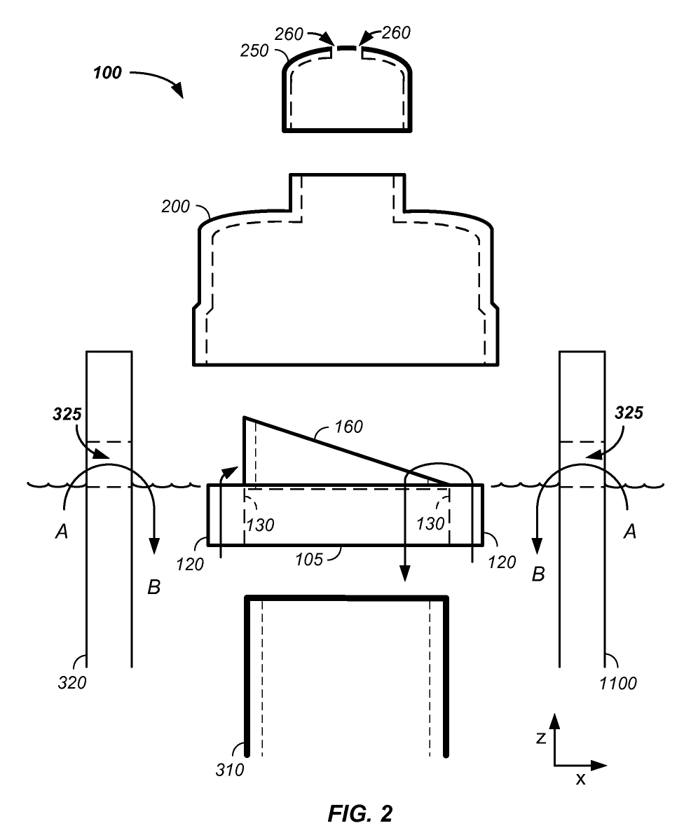

Referring now to FIG. 2, an example of a guard 100 containing multiple elements is illustrated in an exploded view relative to water in a drain system of the aquarium. In this particular example, the guard 100 contains a ring element 105, a cover 200, and a cap 250. The cap 250 contains an inner cutout, which is slidingly engaged about an outer surface of the cover 200. The cover contains an inner cutout surface, which slidingly engages with the outer containment wall of the ring element 105. During use, the inner containment wall 130 of the ring element 105 slidingly engages with an outer surface of the return stand pipe 310. The ring element 105 optionally contains an angled or upper surface 160, which allows the water rising through the opening 110 to spill or cascade over just a portion of the upper surface 160. The optional angled, slanted, or curved upper surface 160 of the ring element reduces noise as the water cascades over the inner containment surface 130 of the ring element 105 from primarily one direction as opposed to splashing over inner containment surface 130 from many directions.

Cap

The guard 100 preferably contains one or more air pressure equalization holes 260 or openings above the water line in the cover 200 and/or cap 250, which allows an equalization of air pressure between a region within the guard 100 and atmosphere. The air pressure equalization holes 260 equalize air pressure, which would not be equal otherwise due to the flowing of water from region B to region C through the otherwise air pressure sealed guard 100 when containing a cover 200 or cap 250 and cover 200.

### EXAMPLE II

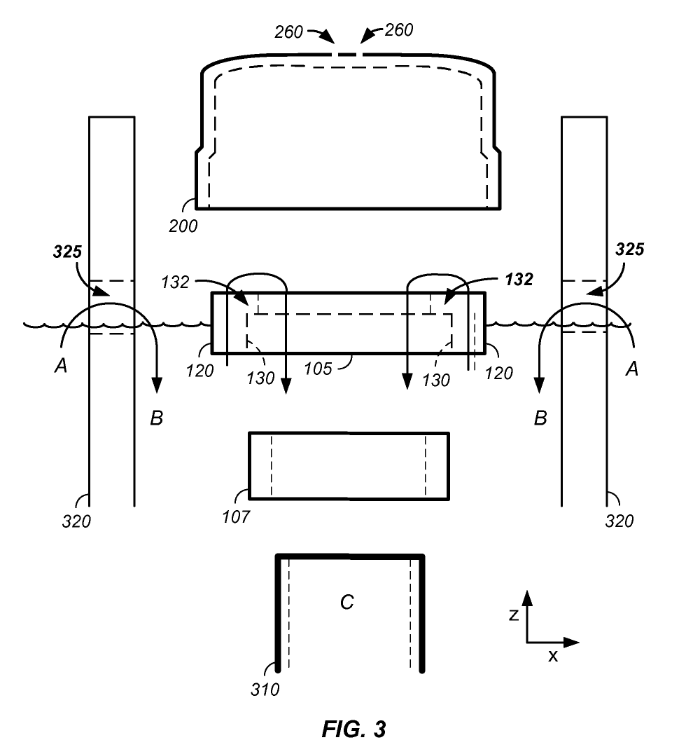

Referring now to FIG. 3, an example of a guard 100 containing multiple elements is illustrated in an exploded view relative to water in a drain system of the aquarium. In this particular example, the guard 100 contains a cover 200, a ring element 105, and an adaptor 107. The cover 200 contains an inner cutout, which is slidingly engaged about an outer surface of the ring element 105. The ring element 105 contains an inner cutout surface, which slidingly engages with the adaptor 107. During use, the adaptor 107 slidingly engages with an outer surface of the return stand pipe 310. The adaptor allows a standard ring element 105 to attach or replaceably attach to drain pipes of varying diameters. In the illustrated embodiment, the cover 200 is illustrated at having the air pressure equalization holes 260. Further, in the illustrated embodiment, the upper surface 260 of the ring element 105 is illustrated as being flat, aligned with the x- and y-axes.

### EXAMPLE III

Referring again to FIG. 3, the ring element 105 is illustrated having an optional stop 132, which sets the height of the spill over level of the guard 100 to be at the top of the drain pipe stand 310. More particularly, the guard 100 slides onto the stand pipe 310 until the top of the stand pipe 310 hits or engages the stop element 132. The stop 132 sets the height of the spill over of the guard 100. Preferably, the aquarist has previously set the height of the stand pipe 310 to approximate the water level of the aquarium. Combined, the stop 132 and spill over level of the guard 100 results in minimal falling and/or splashing of the water in the drain pipe 310.

### EXAMPLE IV

In yet another embodiment, the guard 100 contains one, two, three, four or more pieces including any of:
a cap 250;
a cover 200;
a ring element 105; and
an adaptor 107.

The pieces of the guard are optionally formed or manufactured as one, two, three, or more elements. For example, the cap 250 and cover are optionally manufactured as a single element. In another example, the cover is optionally manufactured as a single element with the ring 105.

### EXAMPLE V

In still yet another embodiment, an x-, y-plane intersecting the ring element 105 and/or guard 100 results in a circular, oval, elliptical, or other geometrical cross-section.

### METHOD OF USE

The method of use of the apparatus is described, supra. A specific example of a method of use of the guard 100 is described. The guard 100 is mounted to the stand pipe 310 during use. Water flows from region A of the aquarium through an overflow to region B of the drain system. Water rises through the opening 110 of the guard 100 and overflows into the stand pipe 310. The opening 110 provides a barrier that prevents movement of snails into the drain system.

Herein, individual elements are described in separated sections and in various examples. In various embodiments, the apparatus and method additionally include permutations and combinations of each of the elements described herein.

Although the invention has been described herein with reference to certain preferred embodiments, one skilled in the art will readily appreciate that other applications may be substituted for those set forth herein without departing from the spirit and scope of the present invention. Accordingly, the invention should only be limited by the Claims included below.

1. An apparatus for use with an aquarium having a drain line, comprising:
a snail guard drain line attachment, comprising:
an outer containment wall and a cylindrical inner containment wall separated by a snail guard opening of less than about three-quarters of an inch; and
an angled overflow surface slanted upward relative to a horizontal surface, said angled overflow surface forming an upper edge of said cylindrical inner containment wall,
wherein during use water flows up through said opening between said outer containment wall and said inner containment wall and subsequently spills from primarily one direction over said angled overflow surface of said cylindrical inner containment wall into the drain line.

2. The apparatus of claim 1, further comprising a set of spacers configured to separate and positionally fix said outer containment wall relative to said inner containment wall, said set of spacers forming a plurality of water flow channels.

3. The apparatus of claim 2, said cylindrical inner containment wall configured to interface with the drain line of the aquarium.

4. The apparatus of claim 3, further comprising:
a detachable cover, an inner surface of said detachable cover forming at least a portion of said outer containment wall of said snail guard, wherein during use noise generated by water cascading over said angled overflow surface is dampened by said detachable cover.

5. The apparatus of claim 4, wherein said set of spacers comprises at least one of:
extensions outwardly protruding from said cylindrical inner containment wall; and
extensions inwardly protruding from said detachable cover.

6. The apparatus of claim 5, said water flow channels comprising a set of snail guard openings, each of said set of snail guard openings comprising a minimum cross-section distance of about one-quarter inch or less.

7. The apparatus of claim 5, further comprising at least two air pressure equalization vents running through an upper surface of said detachable cover.

8. The apparatus of claim 4, further comprising:
a cap, said cap configured to slidingly engage with said detachable cover, said cap comprising at least one air pressure equalization vent running therethrough.

9. The apparatus of claim 1, further comprising:
a mechanical stop integrated into said snail guard drain line attachment, said mechanical stop configured to set an overflow height of said angled overflow surface by mechanically setting a height via an interface with an upper edge of the drain line.

10. The apparatus of claim 9, further comprising:
a ring size adaptor, said ring adaptor configured to interface to both the drain line having a first outer diameter and to an inner diameter of said cylindrical inner housing of said snail guard drain line attachment.

11. The apparatus of claim 1, further comprising:
a cover, an inner surface of said cover forming at least a portion of said outer containment wall of said snail guard, said cover permanently affixed to said inner containment wall by a set of spacers, wherein during use noise generated by water cascading over said angled overflow surface is dampened by said detachable cover.

12. An apparatus for use with an aquarium having a drain line, comprising:
a snail guard drain line attachment, comprising:
an outer containment wall and a cylindrical inner containment wall separated by a snail guard opening of less than about three-quarters of an inch;
an angled overflow surface slanted upward relative to a horizontal surface, said angled overflow surface forming an upper edge of said cylindrical inner containment wall; and
a cover, an inner surface of said cover forming at least a portion of said outer containment wall of said snail guard, said cover permanently affixed to said inner containment wall by a set of spacers, said spacers dividing said opening into a set of channels,
wherein during use water flows up through said set of channels between said outer containment wall and said inner containment wall and subsequently spills from primarily one direction over said angled overflow surface of said cylindrical inner containment wall into the drain line, and
wherein during use noise generated by water cascading over said angled overflow surface is dampened by said cover.
